(19) United States
(12) Patent Application Publication
(10) Pub. No.: US 2024/0397302 A1
(43) Pub. Date: Nov. 28, 2024

(54) SYSTEM AND METHOD FOR SUPPORTING 5G SIGNALING FOR INFLUENCING MOBILE DEVICES

(71) Applicant: Verizon Patent and Licensing Inc., Basking Ridge, NJ (US)

(72) Inventors: Lixia Yan, Basking Ridge, NJ (US); Barry F. Hoffner, Bridgewater, NJ (US)

(21) Appl. No.: 18/324,258

(22) Filed: May 26, 2023

(51) Int. Cl. H04W 8/04; H04W 76/19

(52) U.S. Cl. CPC H04W 8/04; H04W 76/19; H04W 88/06

(57) ABSTRACT

A device may comprise a processor. The processor may be configured to: receive a request for context for a User Equipment device (UE) from a Fourth Generation (4G) core network component; retrieve Fifth Generation (5G) data; and send, to the 4G core network component, a reply comprising the 5G data and an indication whether the 4G core network component is to use the 5G data to instruct the UE.

### BACKGROUND INFORMATION

Fifth Generation (5G) networks implement their core network functions based on a Service Based Architecture (SBA). According to the SBA, each network function fulfills the role of a service producer and/or the role of a service consumer. When a network function assumes the role of a service consumer, the network function may receive a service from a producer; and when a network function assumes the role of a service producer, the network function may provide a service to a consumer. Network functions are mostly self-contained, independent, and reusable. Each network function may expose its functionality to other network functions through a Service Based Interface (SBI).

### BRIEF DESCRIPTION OF THE DRAWINGS

FIG. 1 illustrates concepts described herein;

FIG. 2 illustrates an exemplary network environment in which systems and methods described herein may be implemented;

FIG. 3A depicts exemplary Fifth Generation (5G) core network components, according to an implementation;

FIG. 3B depicts exemplary Fourth Generation (4G) core network components, according to an implementation;

FIG. 4 illustrates example messages, between network components in a standard mode that does not support 5G signaling for influencing a behavior of a User Equipment device (UE);

FIG. 5 illustrates examples messages, between network components in an influence mode that supports 5G signaling for influencing a UE behavior, according to an implementation;

FIGS. 6 and 7 are flow diagrams of exemplary processes that are associated with network components in an influence mode that supports 5G signaling for influencing a UE behavior, according to an implementation; and

FIG. 8 depicts exemplary functional components of a network device according to an implementation.

### DETAILED DESCRIPTION

The following detailed description refers to the accompanying drawings. The same reference numbers in different drawings may identify the same or similar elements. As used herein, the term “multigenerational network” may refer to a cellular network that employs one or more cellular technologies, such as Sixth Generation (6G) network technology, Fifth Generation (5G) network technology, Fourth Generation (4G) network technology, Third Generation (3G) network technology, variants and/or portions of such technologies (e.g., Long Term Evolution (LTE)-Advanced). For example, a multigenerational network may include components of a 5G network and a 4G network.

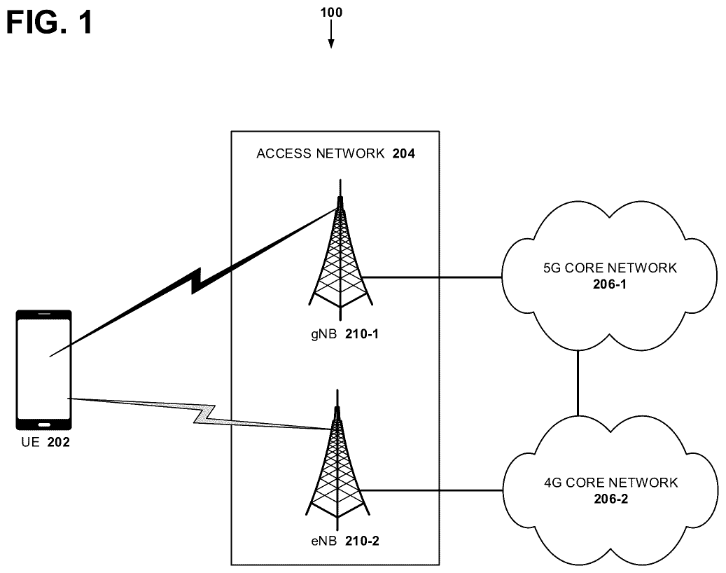

Systems and methods described herein relate to providing 5G signaling to components within a multigenerational network, to influence the behavior of mobile devices that are wirelessly attached to the multigenerational network. FIG. 1 illustrates concepts described herein. As shown, an environment 100 includes an access network 204 and a 5G core network 206-1 and a 4G core network 206-2 (collectively referred to as core networks 206 or generically as core network 206). Access network 204 may include multigenerational cellular network components, such as a Next Generation (NG) or 5G Node B (gNB) 210-1 and an Evolved Node B (eNB) 210-2. 5G core network 206-1 may include 5G core network components and 4G core network 206-2 may include 4G core network components. Assume that a User Equipment device (UE) 202 is a dual connectivity capable of connecting to a 5G core network 206-1 via gNB 210-1 and a 4G core network 206-2 via eNB 210-2.

When UE 202 is in a cell serviced by both gNB 210-1 and eNB 210-2, UE 202 may first attempt to connect to gNB 210-1. UE 202 may establish a Radio Resource Control (RRC) connection and register with 5G core network 206-1. If, however, 5G core network 206-1 is operating under a constraint to limit UE 202 access to its 5G Radio Access Network (RAN) resources, 5G core network 206-1 may influence the behavior of UE 202, such as have UE 202 access its 4G RAN resources to receive communication services. In such a situation, 5G and 4G network components within core networks 206 may need to not only instruct UE 202 to fall back to 4G Radio Access Technology (RAT) but interoperate to support the termination of UE 202 connection to 5G core network 206-1 via gNB 210-1 and to establish its connection to 4G core network 206-2 via eNB 210-2. More broadly, whether core networks 206 direct UE 202 to use 5G RAT or 4G RAT, the components in core networks 206 need to support 5G signaling between the components in a manner consistent with the instructions to UE 202.

The systems and methods described herein support 5G signaling between the components within core network 206 for influencing the behavior of UE 202. As described below, 5G core network components and 4G core network components may operate in either a standard mode or an influence mode. In the influence mode, the 5G and 4G core network components may generate and use 5G signals for interacting with each other, to provide consistent instructions for UE 202 to anchor on the proper radio network.

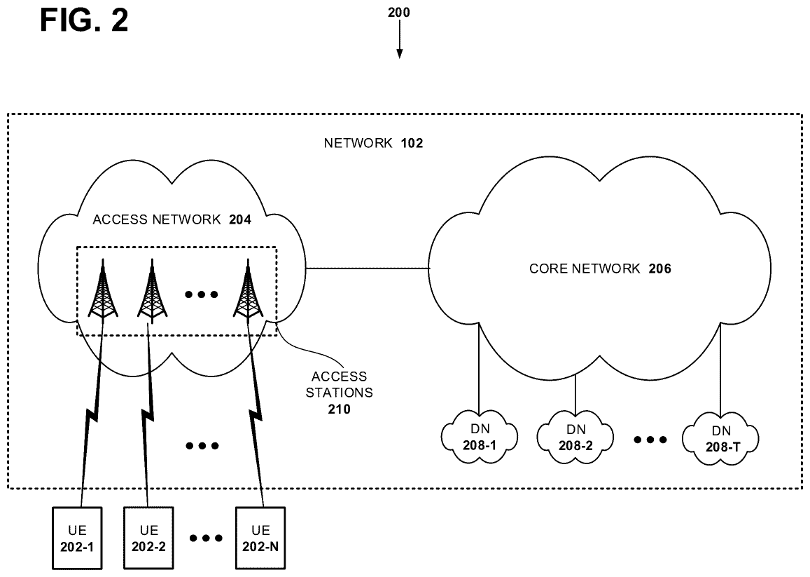

FIG. 2 illustrates an exemplary network environment 200 in which systems and methods described herein may be implemented. As shown, network environment 200 may include UEs 202-1 through 202-N (collectively referred to as UEs 202 and generically referred to as UE 202), access network 204, core network 206, and data networks (DNs) 208-1 through 208-T (collectively referred to as data networks 208 and generically as data network 208). Access network 204, core network 206, and data networks 208 may be part of a multigenerational network 102 (also referred to as provider network 102 or simply as network 102).

UEs 202 may include a dual connectivity wireless communication devices capable of 4G (e.g., Long-Term Evolution (LTE)) communication and 5G New Radio (NR) communication. Examples of UE 202 include: a Fixed Wireless Access (FWA) device; a Customer Premises Equipment (CPE) device with 4G and 5G capabilities; a smart phone; a tablet device; a wearable computer device (e.g., a smart watch); a global positioning system (GPS) device; a laptop computer; a media playing device; a portable gaming system; an autonomous vehicle navigation system; a sensor,; and an Internet-of-Things (IoT) device. In some implementations, UE 202 may include a wireless Machine-Type-Communication (MTC) device that communicates with other devices over a machine-to-machine (M2M) interface, such as LTE-M or Category M1 (CAT-M1) devices and Narrow Band (NB)-IoT devices.

Access network 204 may allow UE 202 to access core network 206. To do so, access network 204 may establish and maintain, with participation from UE 202, an over-the-air channel with UEs 202; and maintain backhaul channels with core network 206. Access network 204 may relay information through such channels, from UEs 202 to core network 206 and vice versa. Access network 204 may include an LTE radio network and/or a 5G NR network, or another advanced radio network. These networks may include many central units (CUs), distributed units (DUs), radio units (RUs), and wireless stations, some of which are illustrated in FIG. 2 as access stations 210 for establishing and maintaining over-the-air channels with UEs 202. In some implementations, access station 210 may include a 4G, 5G, or another type of base station (e.g., gNB 210-1, eNB 210-2, etc.) that includes one or more radio frequency (RF) transceivers. In some implementations, access station 210 may be part of an evolved Universal Mobile Telecommunications Service (UMTS) Terrestrial Radio Access Network (eUTRAN).

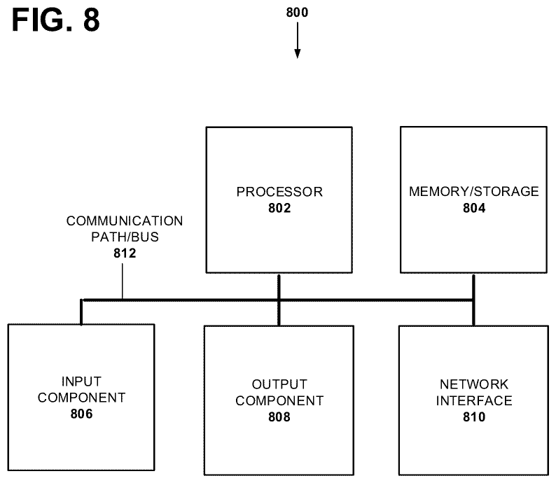

Core network 206 may manage communication sessions of subscribers connecting to core network 206 via access network 204. For example, core network 206 may establish an Internet Protocol (IP) connection between UEs 202 and data networks 204. The components of core network 206 may be implemented as dedicated hardware components or as virtualized functions implemented on top of a common shared physical infrastructure using Software Defined Networking (SDN). For example, an SDN controller may implement one or more of the components of core network 206 using an adapter implementing a virtual network function (VNF) virtual machine, a Cloud Native Function (CNF) container, an event driven serverless architecture interface, and/or another type of SDN component. The common shared physical infrastructure may be implemented using one or more devices 800 described below with reference to FIG. 8 in a cloud computing center associated with core network 206.

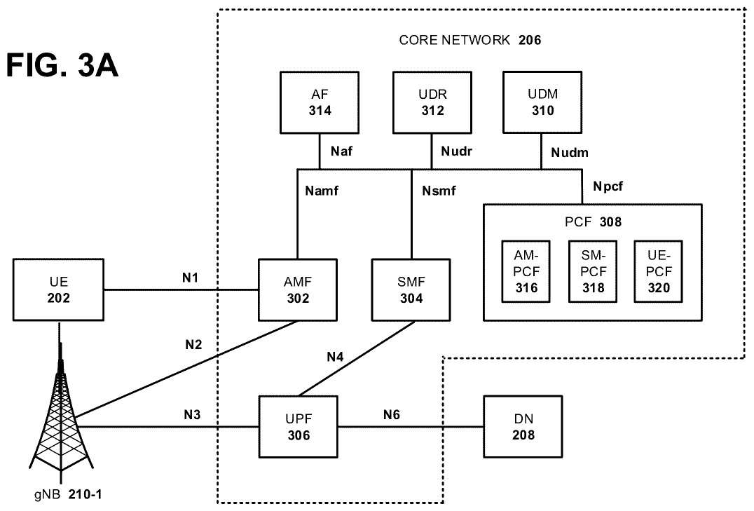

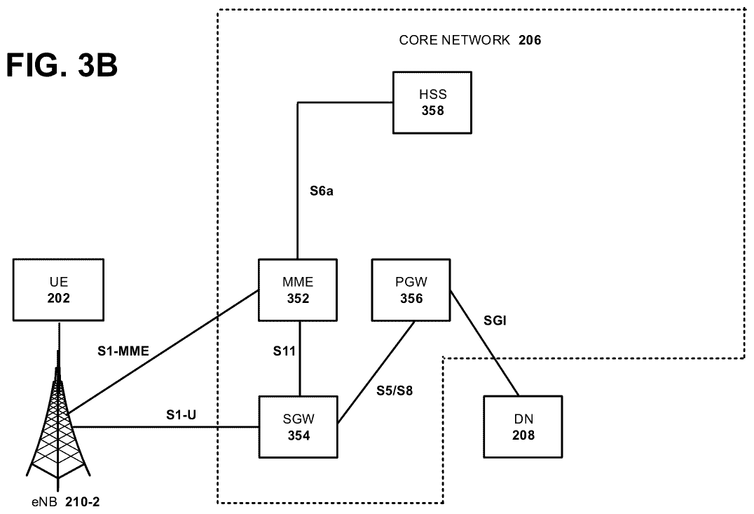

Core network 206 may include 5G core network components, 4G core network components, and/or another type of core network components. These components may be part of the system for supporting 5G signaling between the components within core network 206 for influencing the behavior of UE 202. Some of the core network components may operate in a standard mode and/or an influence mode. The 5G core network components, the 4G core network components, and their behavior when in the influence mode to support the 5G signaling for influencing the behavior of UE 202 are described in greater detail with reference to FIGS. 3A, 3B, and 4-7.

Data networks 208 may include one or more networks connected to core networks 206. In some implementations, a particular data network 208 may be associated with a data network name (DNN) in 5G and/or an Access Point Name (APN) in 4G. UE 202 may request a connection to data network 208 using a DNN or APN. Each data network 208 may include, and/or be connected to and enable communications with a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, and/or an LTE network), an ad hoc network, a telephone network (e.g., the Public Switched Telephone Network (PSTN) or a cellular network), an intranet, or a combination of networks. Data network 208 may include an application server (also referred to as application). An application may provide services for a program or an application running on UEs 202 and may establish communication sessions with UEs 202 via core network 206.

For clarity, FIG. 2 does not show all components that may be included in network environment 200 (e.g., routers, bridges, wireless access points, additional networks, additional access stations 210, data centers, portals, etc.). Depending on the implementation, network environment 200 may include additional, fewer, different, or a different arrangement of components than those illustrated in FIG. 2.

FIG. 3A depicts exemplary 5G core network components 302-314 in core network 206 according to an implementation. As indicated above, one or more of 5G core network components 302-314 may be capable of operating in the influence mode to support 5G signaling for influencing the behavior of UE 202. Referring to FIG. 3A, core network 206 may include Access and Mobility Management Function (AMF) 302, a Session Management Function (SMF) 304, a User Plane Function (UPF) 306, a Policy Control Function (PCF) 308, a Unified Data Management (UDM) 310, a Unified Data Repository (UDR) 312, and an Application Function (AF) 314. Although core network 206 is depicted as including network components 302-314 in FIG. 3A, in other implementations, core network 206 may include additional, fewer, and/or different 5G core network components than those illustrated in FIG. 3A. For example, core network 206 may further include an Authentication Server Function (AUSF), a Charging Function (CHE), and a Network Slice Selection Function (NSSF).

AMF 302 may perform registration management, connection management, reachability management, mobility management, lawful intercepts, Short Message Service (SMS) transport between UE 202 and a Short Message Service Function (SMSF), session management messages transport between UE 202 and SMF 304, access authentication and authorization, location services management, functionality to support non-Third Generation Partnership Program (3GPP) access networks, and/or other types of management processes. Other network functions may communicate with AMF 302 over an Namf interface. In addition, AMF 302 may interact with UE 202 and access station 210 (implemented as a gNB 210-1 in FIG. 3A) over N1 and N2 interfaces, respectively.

In the influence mode, AMF 302 may convey Access and Mobility (AM) Management data to network components and one or more policy parameters from PCF 308 to the network components. For example, when PCF 308 responds to a request from AMF 302 for a policy, PCF 308 may forward a policy parameter, such as the OVERWRITE_4G parameter.

When a network component requests AM data from AMF 302, AMF 302 may pass the AM data along with the OVERWRITE_4G parameter to the network component.

SMF 304 may perform session establishment, session modification, and/or session release, perform Internet Protocol (IP) address allocation and management, perform Dynamic Host Configuration Protocol (DHCP) functions, perform selection and control of UPF 306, configure traffic steering at UPF 306 to guide the traffic to the correct destinations, terminate interfaces toward PCF 308, perform lawful intercepts, charge data collection, support charging interfaces, control and coordinate of charging data collection, terminate session management parts of Non-Access Stratum (NAS) messages, perform downlink data notification, manage roaming functionality, and/or perform other types of control plane processes for managing user plane data. Other network functions or components may communicate with SMF 304 over an Nsmf interface.

UPF 306 may maintain an anchor point for intra/inter-RAT mobility, maintain an external protocol data unit (PDU) point of interconnect to a particular data network (e.g., data network 208), perform packet routing and forwarding, perform the user plane part of policy rule enforcement, perform packet inspection, perform lawful intercept, perform traffic usage reporting, perform Quality of Service (QoS) handling in the user plane, perform uplink traffic verification, perform transport level packet marking, perform downlink packet buffering, forward an “end marker” to a RAN node (e.g., gNB 210-1), and/or perform other types of user plane processes. UPF 306 may interact with gNB 210-1, SMF 304, and data network 208 over N3, N4, and N6 interfaces.

PCF 308 may support policies to control network behavior, provide policy rules to control plane functions (e.g., to SMF 304), access subscription information relevant to policy decisions, perform policy decisions, and/or perform other types of processes associated with policy enforcement. Other network functions may communicate with PCF 308 over an Npcf interface.

As further shown, PCF 308 may include an access and mobility (AM)-PCF 316, a session management (SM)-PCF 318, and a UE-PCF 320. AM-PCF 316 may interact with AMF 302 and may provide policies that relate to access and mobility management to AMF 302; SM-PCF 318 may interact with SMF 304 and may provide policies that relate to session management to SMF 304; and UE-PCF 320 may provide policies that relate to handling UE 202.

In the influence mode, AM-PCF 316 may provide a 5G signal (or a message) to 5G core network components for influencing the behavior of UE 202. More specifically, AM-PCF 316 may determine whether UE 202 is to use 4G RAT to access network 102 based on conditions of network 102. Examples of such conditions include: the number of UEs 202, which are already connected to and receiving services from network 102 via 5G or 4G, exceeds a threshold; whether the subscription level of the user of the UE 202 is a premium user or a preferred user; whether the volumes of 5G and/or 4G traffic are above thresholds (e.g., thresholds that indicate 5G traffic congestion, 4G traffic congestion, etc.); whether a network operator has disabled further UE 202 use of 4G or 5G (e.g., for network maintenance, upgrade, or repair); and whether there are any network issues in 5G or 4G (e.g., broken routes, component outage, or another network condition that leads to a QoS level falling below a Service Level Agreement (SLA). Based on such a determination, AM-PCF 316 may send a 5G signal to AMF 302.

In one example regarding AM-PCF 308 generating a 5G signal for influencing the behavior of UE 202, assume that AMF 302 requests AM-PCF 316 to issue a policy for UE 202 which sent a registration request to network 102. In response, AM-PCF 316 may determine that permitting UE 202 to use 5G RAT to access network 102 would result in too many UEs 202 depleting 5G resources of network 102. Accordingly, AM-PCF 316 may issue, to AMF 302, a policy with OVERWRITE_4G set to True or “1”—a 5G signal. Depending on the implementation, AM-PCF 316 may use different logic to determine whether UE 202 should use a 4G or 5G RAT.

UDM 310 may maintain subscription information for UEs 202, manage subscriptions, generate authentication credentials, handle user identification, perform access authorization based on subscription data, perform network function registration management, maintain service and/or session continuity by maintaining assignment of SMF 304 for ongoing sessions, support SMS delivery, support lawful intercept functionality, and/or perform other processes associated with managing user data. UDM 310 may store the data that it manages in UDR 312. Network functions may interact with UDM 310 via an Nudm interface. UDR 312 may store subscription data/profiles, policy data, application data, and exposure data. The subscription data may include information that is associated with the subscribers of networks 102. The subscription data may be made available to other NFs via UDM 310. The policy data may include policy rules and parameters associated with the policy rules. The application data may comprise information and/or data collected by applications.

AF 316 may include applications (e.g., server applications) that render specific services to applications or components that run on UEs 202. Network functions may interact with AF 316 via an Naf interface.

As shown in FIG. 3A, UE 202 may communicate with AMF 302 via gNB 210-1, which is a 5G implementation of access station 210. gNB 210-1 may include devices and components that enable UE 202 to connect to core network 206 using 5G NR RAT. For example, gNB 210-1 may service one or more cells, with each cell being served by a wireless transceiver with an antenna array configured for millimeter (mm)-wave wireless communication. gNB 210-1 may communicate with AMF 302 using an N2 interface and communicate with UPF 306 using an N3 interface.

FIG. 3B depicts exemplary 4G core network components 352-358 in core network 206 according to an implementation. As indicated above, one or more of 4G core network components 352-358 may be capable of operating in the influence mode to support 5G signaling for influencing UE 202. Referring to FIG. 3B, core network 206 may include: a Mobility Management Entity (MME) 352, a Serving Gateway (SGW 354, a Packet Data Network Gateway (PGW) 356, and Home Subscriber Server (HSS) 358. Although not shown, core network 206 may further include other 4G core network components.

MME 302 may implement control plane processing for core network 206. For example, MME 302 may manage the mobility of UE 202, implement tracking and paging procedures for UE 202, activate and deactivate bearers for UE 202, authenticate a user of UE 202, and/or interface to non-LTE radio access networks. A bearer may represent a logical channel with particular QoS requirements. MME 352 may also select a particular SGW 354 for a particular UE 202. MME 352 may communicate with SGW 330 through an S11 interface. S11 interface may be used to create and manage a new session for a particular UE 202. S11 interface may be activated when MME 352 needs to communicate with SGW 354, such as when the particular UE 202 attaches to core network 206, when bearers need to be added or modified for an existing session for the particular UE 202, when a connection to a different PGW 356 needs to be created, or during a handover procedure (e.g., when the particular UE 202 needs to switch to a different SGW 354).

In the influence mode, MME 352 may receive, from AMF 302, a 5G signal, such as OVERWRITE_4G parameter (e.g., set to True, False, 1, 0, etc.) and AM data. The AM data may include, for example, UE Aggregate Maximum Bit Rate (AMBR), Presence Reporting Areas (PRAs), a Radio Frequency Selection Policy (RSP) identifier (ID), restrictions on access to core network functions, and/or access restrictions on data. When the OVERWRITE_4G parameter from AMF 302 has the value of True or 1, MME 352 may apply the AM data received from AMF 302 in handling UE 202. Otherwise (e.g., OVERWRITE_4G=False or 0), MME 352 may obtain subscription data or other data from HSS 358 (HSS data) and apply the data in handling UE 202.

SGW 354 may provide an access point to and from UE 202, may handle forwarding of data packets for UE 202, and may act as a local anchor point during handover procedures between different eNBs 210-2. SGW 354 may interface with PGW 356 through an S5/S8 interface. PGW 356 may function as a gateway to data network 208 (when data network 208 is an IP network) through an SGi interface. UE 202, while connected to SGW 354, may be connected to multiple PGWs 356, one for each data network 208 with which UE 202 communicates.

PGW 356 may provide control plane functions and user plane functions associated with communication sessions. As a gateway to data networks 208, PGW 356 may function, with respect to other 4G core network components, similarly as UPF 306 does with respect to other 5G core network components.

HSS 358 may store subscription information associated with UEs 202 and/or information associated with users of UEs 202. For example, HSS 358 may store subscription profiles that include authentication, access, and/or authorization information. Each subscription profile may include information identifying UEs 202, authentication and/or authorization information for UEs 202, services enabled and/or authorized for UEs 202, device group membership information for UEs 202, and/or other types of information associated with UEs 202. HSS 358 include user information and/or UE information that is consistent with the information stored at UDR 312. HSS 358 may communicate with MME 352 through an S6a interface.

In FIG. 3B, UE 202 may communicate with core network 206 via eNB 210-2, which is a 4G implementation of access station 210. The eNB 210-2 may interface with core network 206 via both a control plane S1-MME interface and a data plane S1-U interface. The eNB 210-2 may use the S1-MME interface to interface with MME 352 and use S1-U interface to interface with SGW 354.

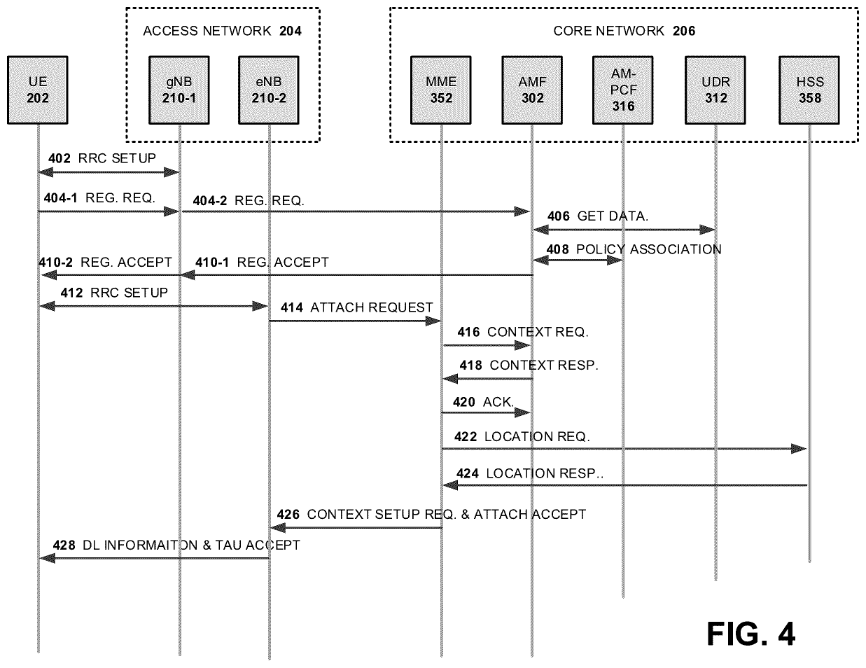

FIG. 4 illustrates example messaging, between network components in a standard mode that does not support 5G signaling for influencing the behavior of UEs 102, according to an implementation. Because the standard mode does not correctly support signaling for influencing UE behavior, the network components in the standard mode may cause UE 202 to incorrectly switch from 4G RAT to 5G RAT. Assume that UE 202 is in a cell serviced by both gNB 210-1 and eNB 210-2. When both gNB 210-1 and eNB 210-2 are available for connection, UE 202 may first attempt to connect to network 102 via 5G RAT before attempting to connect via 4G RAT.

As shown, UE 202 may exchange messages with gNB 210-1 to establish an RRC connection with gNB 210-1 (arrow 402). Upon establishing the RRC connection, UE 202 may forward a request for registration to gNB 210-1 (arrow 404-1), which then may relay the request to AMF 302 (arrow 404-2). In response, AMF 302 may retrieve data pertaining to UE 202 (e.g., the AM data described above) from a subscription profile, for the user of UE 202, in UDR 312 (arrow 406). AMF 302 may cache the data. Next, AMF 302 may request AM-PCF 316 for a policy for associating with UE 202 (arrow 408). The policy may specify what rules to apply to UE 202 that is registered at network 102. In response to the policy request, AM-PCF 316 may decide whether to permit UE 202 to use 5G RAT to access network 102 to receive its services or to cause UE 202 to switch to a 4G RAT. As described above with reference to FIG. 3A, when making the decision, AM-PCF 316 may take into consideration multiple factors. The factors may include, for example: whether the number of UEs 202, which are already connected to and receiving services from network 102 via 5G, exceeds a threshold; whether the subscription level of the user of the UE 202 is a premium user or a preferred user; whether the volumes of 5G and/or 4G traffic are above thresholds (e.g., thresholds that indicate 5G traffic congestion, 4G traffic congestion, etc.); whether a network operator has disabled further UE 202 use of 4G or 5G (e.g., for network maintenance, upgrade, or repair); and whether there are any network issues in 5G or 4G (e.g., broken routes, component outage, or another network condition) that leads to a QoS level falling below a SLA threshold.

Assume that AM-PCF 316 decides to cause UE 202 to fall back to the 4G RAT to receive services from network 102. That is, according to AM-PCF 316, the correct behavior for UE 202 is to switch to the 4G RAT. AM-PCF 316 may then forward its policy to AMF 302, with an indication that the UE 202 is to fall back to the 4G RAT (arrow 408). Next, AMF 302 may send a registration accept reply 410-1 to gNB 210-1. The gNB 210-1 may relay the accept reply to UE 202 (arrow 410-2). The reply 410-2 may include the instructions for UE 202 to fall back to the 4G RAT.

When UE 202 receives the registration accept reply 410-2, UE 202 may recognize the instructions in the reply 410-2 to fall back to the 4G RAT. Accordingly, UE 202 may terminate its RRC connection to gNB 210-1 and establish an RRC connection with eNB 210-2 (arrow 412). Next, eNB 210-2 may forward an attach request (which includes a Tracking Area Update (TAU) message) to MME 352 (arrow 414). MME 352 may then exchange a series of messages with AMF 302. For example, MME 352 may request a UE context from AMF 302 (arrow 416), receive a UE context response (which includes the AM data cached at AMF 302) from AMF 302 (arrow 418), and answer AMF 302 with an acknowledgment (arrow 420). Furthermore, based on the TAU message in the attach request, AMF 352 may send a location update message to HSS 358 (arrow 422) and receive a location update response and HSS data from HSS 358 (arrow 424).

When MME 352 receives the context reply from AMF 302 at arrow 418, MME 352 may not know whether the UE 202 is to use the AM data from AMF 302 or to use the HSS data from HSS 358. In this situation, MME 352 may default to its standard behavior, which is to honor the HSS data from HSS 358. The HSS data may indicate that UE 202 is capable of 5G communication and therefore, honoring the HSS data means that UE 202 is to switch to the 5G RAT—although this is not the correct behavior specified earlier by AMF-PCF 316. Nevertheless, MME 352 may forward an accept reply (arrow 426), with an indication that UE 202 is to use 5G RAT to receive its services from network 102, to eNB 210-2. In addition, MME 426 may forward a context set up request to eNB 210-2 (arrow 426). In response, eNB 210-2 may forward a TAU accept message and some downlink information, which may include the instruction to UE 202 to switch to 5G RAT (arrow 428).

When UE 202 receives the instruction, UE 202 may determine that UE 202 is to terminate its RRC connection with eNB 210-2 and is to reestablish its RRC connection to gNB 210-1. Therefore, after terminating its RRC connection to eNB 210-2, UE 202 may return to signaling at 402, to repeat messaging 402-428. The result may be UE 202 “ping-ponging” (e.g., switching back and forth) its connection between gNB 210-1 AND eNB 210-2—an undesirable UE behavior. The UE behavior may be a result of 5G components 302-314 and 4G components 352-358 in the standard mode, which does not support 5G signaling for influencing the behavior of UE 202.

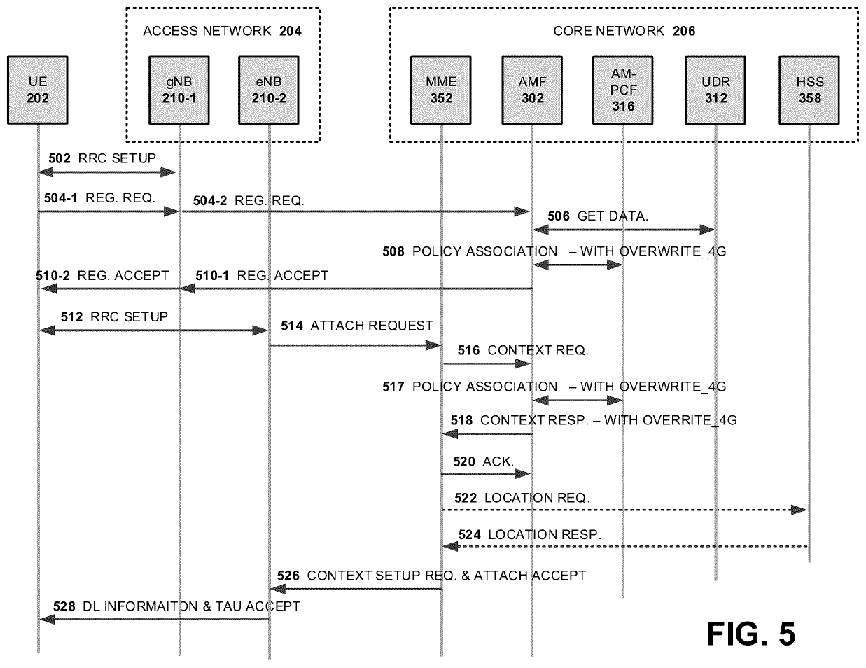

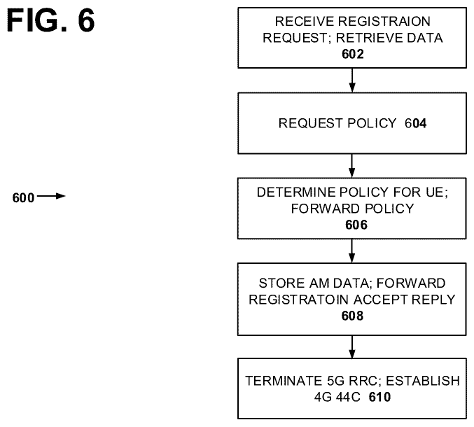

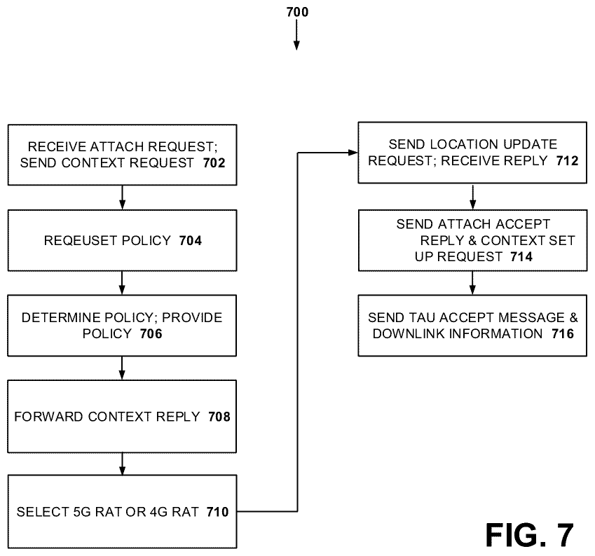

FIG. 5 illustrates examples messages, between network components in the influence mode that supports 5G signaling for influencing the behavior of UE 202. FIGS. 6 and 7 are flow diagrams of exemplary processes 600 and 700 that are associated network components in the influence mode. FIG. 5 and the arrows shown therein are not intended to indicate every message that is exchanged between the components; and FIGS. 6 and 7 and the blocks illustrated therein are not intended to depict every action performed by the network components. In the following, assume that UE 202 is in a cell serviced by both gNB 210-1 and eNB 210-2. When both gNB 210-1 and eNB 210-2 are available for connection, UE 202 may first attempt to connect to network 102 by using 5G RAT before attempting to connect to network 102 by using 4G RAT.

As shown, UE 202 may exchange messages with gNB 210-1 to establish an RRC connection with gNB 210-1 (arrow 502). Upon establishing the RRC connection, UE 202 may forward a request for registration to gNB 210-1 (arrow 504-1), which then may relay the request to AMF 302 (arrow 504-2). Consequently, AMF 302 may receive the registration request (FIG. 6, block 602; arrow 504-2). In response, AMF 302 may retrieve data pertaining to UE 202 (e.g., the AM data described above) from the subscription profile, for the user of UE 202, in UDR 312 (block 602; arrow 506) and cache the data. Next, AMF 302 may request a policy from AM-PCF 316 for associating the policy with UE 202 (block 604; arrow 508). The policy may specify what rules to apply to UE 202. In response to the policy request, AM-PCF 316 may determine the policy (e.g., whether to permit UE 202 to use 5G RAT to access network 102 to receive services or cause UE 202 to switch to 4G RAT) (block 606). As described above with reference to FIG. 3A, AM-PCF 316 may take into consideration multiple factors in determining the policy. The factors may include, for example: whether the number of UEs 202, which are already connected to and receiving services from network 102 via 5G, exceeds a threshold; whether the subscription level of the user of the UE 202 is a premium user or a preferred user; whether the volumes of 5G and/or 4G traffic are above thresholds (e.g., thresholds that indicate 5G traffic congestion, 4G traffic congestion, etc.); whether a network operator has disabled further UE 202 use of 4G or 5G (e.g., for network maintenance, upgrade, or repair); and whether there are any network issues in 5G or 4G (e.g., broken routes, component outage, or another network condition) that leads to a QoS level falling below a SLA threshold.

Assume that AM-PCF 316 decides to cause UE 202 to fall back to the 4G RAT to receive services from network 102. That is, according to AM-PCF 316, the correct behavior for UE 202 is to switch to the 4G RAT. AM-PCF 316 may forward the policy to AMF 302, with an indication (e.g., OVERWRITE_4G=True) that the UE 202 is to apply the AM data and fall back to 4G RAT (block 606; arrow 508). Next, AMF 302 may store or cache the AM data (block 608) and send a registration accept reply 510-1 to gNB 210-1 (block 608; arrow 510-1). The gNB 210-1 may relay the accept reply to UE 202 (arrow 510-2). The reply 510-2 may include the instructions for UE 202 to fall back to the 4G RAT.

When UE 202 receives the registration accept reply 510-2 (block 610), UE 202 may recognize the instructions in the reply 510-2 to fall back to the 4G RAT. Therefore, UE 202 may terminate its RRC connection to gNB 210-1 and establish an RRC connection with eNB 210-2 (block 610; arrow 512). The eNB 210-2 may then forward an attach request, which includes a TAU message, to MME 352 (arrow 514). When MME 352 receives the request (FIG. 7, block 702), MME 352 may recognize that UE 202 has previously registered with AMF 302 and may request a UE context from AMF 302 (block 702; arrow 516).

AMF 302, rather than responding to MME 352 as described above with reference to FIG. 4, may request AM-PCF 316 to provide a policy to AMF 302, for associating with UE context (block 704; arrow 517). AM-PCF 316 may determine the policy and provide the policy to AMF 302 (block 706; arrow 517). When determining the policy, if AM-PCF 316 has determined that UE 202 is to use 4G RAT to access network 102, AM-PCF 316 may include the OVERWRITE_4G parameter=True with the policy to AMF 302, indicating that UE 202 is to fall back to 4G RAT. AMF 302 may then forward its context reply (block 708), along with OVERWRITE_4G=True, to MME 352 (arrow 518). The context reply may include the AM data that was cached earlier at AMF 302. MME 352 may respond with an acknowledgement message to AMF 302 (arrow 520).

In contrast to FIG. 4, in FIG. 5, when MME 352 receives the context reply from AMF 302 (arrow 518), MME 352 may be configured to select, based on the value of OVERWRITE_4G, 5G or 4G RAT for UE 202 to use to receive services from network 102 (block 710). For example, when MME 352 receives the context reply along with OVERWRITE_4G=True, MME 352 may decide to apply the AM data from AMF 302 and not query HSS 358 for data. Depending on the implementation, MME 352 may also send a location update request message to HSS 358 (block 712; arrow 522) and receive a reply (block 712; arrow 524). In such an implementation, MME 352 may still apply the AM data from AMF 302 and ignore the HSS data from HSS 358. Because OVERWRITE_4G=True is in effect, however, MME 352 may select 4G RAT for UE 202. That is, in the influence mode MME 352 may support the signaling originating from AM-PCF 316 to influence the behavior of UE 202.

After receiving the location reply, MME 352 may forward an attach accept reply that indicates that UE 102 cannot attach to gNB 210-1 (block 714; arrow 526). In addition, MME 352 may forward a context set up request to eNB 210-2 (block 714; arrow 526). The context setup request may indicate that UE 102 cannot be handed over to gNB 210-1. In response, eNB 210-2 may forward a TAU accept message and some downlink information, which may include the instructions to UE 202 to continue to use 4G RAT (block 716; arrow 528). In FIG. 5, because 5G components 302-314 and 4G components 352-358 are in the influence mode support 5G signaling for influencing the behavior of UE 202, UE 202 may receive the instruction consistent with AMF-PCF 316 policy for UE 202 to use 4G RAT. Accordingly, UE 202 may not attempt to reconnect with gNB 210-2 or connect back and forth between gNB 210-1 and 210-2—avoiding the ping-pong scenario described above with reference to FIG. 4.

FIG. 8 depicts exemplary components of a network device 800. Network device 800 may correspond to or be included in any of the devices and/or components illustrated in FIGS. 1, 2, 3A, 3B, 4, and 5 (e.g., network 102, UE 202, access network 204, core network 206, data network 208, gNB 210-1, eNB 210-2, 5G core network components 302-314, and 4G core network components 352-358). In some implementations, network devices 800 may be part of a hardware network layer on top of which other network layers and NFs may be implemented.

As shown, network device 800 may include a processor 802, memory/storage 804, input component 806, output component 808, network interface 810, and communication path 812. In different implementations, network device 800 may include additional, fewer, different, or different arrangement of components than the ones illustrated in FIG. 8. For example, network device 800 may include line cards, switch fabrics, modems, etc.

Processor 802 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 800 and/or executing programs/instructions.

Memory/storage 804 may include static memory, such as read only memory (ROM), and/or dynamic memory, such as random access memory (RAM), or onboard cache, for storing data and machine-readable instructions (e.g., programs, scripts, etc.). Memory/storage 804 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 804 may be external to and/or removable from network device 800. Memory/storage 804 may include, for example, a Universal Serial Bus (USB) memory stick, a dongle, a hard disk, off-line storage, a Blu-Ray® disk (BD), etc. Memory/storage 804 may also include devices that can function both as a RAM-like component or persistent storage, such as Intel® Optane memories.

Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 806 and output component 808 may provide input and output from/to a user to/from network device 800. Input/output components 806 and 808 may include a display screen, a keyboard, a mouse, a speaker, a microphone, a camera, a DVD reader, USB lines, and/or other types of components for obtaining, from physical events or phenomena, to and/or from signals that pertain to network device 800.

Network interface 810 may include a transceiver (e.g., a transmitter and a receiver) for network device 810 to communicate with other devices and/or systems. For example, via network interface 810, network device 800 may communicate over a network, such as the Internet, an intranet, cellular, a terrestrial wireless network (e.g., a WLAN, WIFI, WIMAX, etc.), a satellite-based network, optical network, etc. Network interface 810 may include a modem, an Ethernet interface to a LAN, and/or an interface/connection for connecting network device 800 to other devices (e.g., a Bluetooth interface).

Communication path or bus 812 may provide an interface through which components of network device 800 can communicate with one another.

Network device 800 may perform the operations described herein in response to processor 802 executing software instructions stored in a non-transient computer-readable medium, such as memory/storage 804. The software instructions may be read into memory/storage 804 from another computer-readable medium or from another device via network interface 810. The software instructions stored in memory/storage 804, when executed by processor 802, may cause processor 802 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions, messages, and/or signals, have been described with reference to FIGS. 4-7. the order of the actions, messages, and signals may be modified in other implementations. In addition, non-dependent actions, messages, and signals may represent actions, messages, and signals that can be performed, sent, and/or received in parallel and in different orders. Furthermore, each actions, messages, and signals illustrated may include one or more other actions, messages, and/or signals.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A device comprising:
a processor configured to:
receive a request for context information for a User Equipment device (UE) from a Fourth Generation (4G) core network component;
retrieve Fifth Generation (5G) data; and
send, to the 4G core network component, a reply comprising the 5G data and an indication whether the 4G core network component is to use the 5G data to instruct the UE.

2. The device of claim 1, wherein the device comprises an Access and Mobility Management Function (AMF), and wherein the 4G core network component comprises a Mobility Management Entity (MME).

3. The device of claim 1, wherein the processor is further configured to:
receive the indication from a Policy Control Function (PCF).

4. The device of claim 3, wherein the PCF is configured to:
determine whether the UE is to terminate a Radio Resource Control (RRC) connection established with a 5G Node B (gNB) and establish a RRC connection with an Evolved Node B (eNB); and
forward a result of the determination as a parameter value to the 4G core network component.

5. The device of claim 1, wherein when the processor retrieves the 5G data, the processor is configured to:
retrieve the 5G data from a Unified Data Repository (UDR).

6. The device of claim 5, wherein the 5G data comprises at least one of:
a UE Aggregate Maximum Bit Rate (AMBR) for the UE,
a Presence Reporting Area (PRA) identifier (ID) for the UE; or
a Radio Frequency Selection Policy (RSP) ID for the UE.

7. The device of claim 1, wherein the 4G core network component comprises a Mobility Management Entity (MME) configured to:
retrieve 4G data from a Home Subscriber Server (HSS) to instruct the UE.

8. The device of claim 1, wherein the processor is configured to:
receive a first registration request for the UE; and
send a second request to a Policy Control Function (PCF) to obtain a policy to associate with the UE.

9. A system comprising:
a first component configured to:
receive a request for context information for a User Equipment device (UE) from a Fourth Generation (4G) core network component;
retrieve Fifth Generation (5G) data; and
send, to the 4G core network component, a reply comprising the 5G data and an indication whether the 4G core network component is to use the 5G data to instruct the UE.

10. The system of claim 9, wherein the first component comprises an Access and Mobility Management Function (AMF), and wherein the 4G core network component comprises a Mobility Management Entity (MME).

11. The system of claim 9, wherein the first component is further configured to:
receive the indication from a Policy Control Function (PCF).

12. The system of claim 11, wherein the PCF is configured to:
determine whether the UE is to terminate a Radio Resource Control (RRC) connection established with a 5G Node B (gNB) and establish a RRC connection with an Evolved Node B (eNB); and
forward a result of the determination as a parameter value to the 4G core network component.

13. The system of claim 9, wherein when the first component retrieves the 5G data, the first component is configured to:
retrieve the 5G data from a Unified Data Repository (UDR).

14. The system of claim 13, wherein the 5G data comprises at least one of:
a UE Aggregate Maximum Bit Rate (AMBR) for the UE,
a Presence Reporting Area (PRA) identifier (ID) for the UE; or
a Radio Frequency Selection Policy (RSP) ID for the UE.

15. The system of claim 9, wherein the 4G core network component comprises a Mobility Management Entity (MME) configured to:
retrieve 4G data from a Home Subscriber Server (HSS) to instruct the UE.

16. The system of claim 9, wherein the first component is further configured to:
receive a first registration request for the UE; and
in response to the first registration request, send a second request to a Policy Control Function (PCF) to obtain a policy to associate with the UE.

17. A method comprising:
receiving, at a 5G core network component, a request for context information for a User Equipment device (UE) from a Fourth Generation (4G) core network component;
retrieving Fifth Generation (5G) data; and
sending, to the 4G core network component, a reply comprising the 5G data and an indication whether the 4G core network component is to use the 5G data to instruct the UE.

18. The method of claim 17, wherein the 5G core network component comprises an Access and Mobility Management Function (AMF), and wherein the 4G core network component comprises a Mobility Management Entity (MME).

19. The method of claim 17, further comprising:
receiving the indication from a Policy Control Function (PCF).

20. The method of claim 19, further comprising:
determining, by the PCF, whether the UE is to terminate a Radio Resource Control (RRC) connection established with a 5G Node B (gNB) and establish a RRC with an Evolved Node B (eNB); and
forwarding, by the PCF, a result of the determination as a parameter value to the 4G core network component.
